(19) United States
(12) Patent Application Publication
(10) Pub. No.: US 2026/0296542 A1
(43) Pub. Date: Oct. 1, 2026

(54) Method for Operating a Lane Guidance Assistant of a Vehicle While Taking into Consideration Driver Interventions, Lane Guidance Assistant, and Vehicle

(71) Applicant: Bayerische Motoren Werke Aktiengesellschaft, Muenchen (DE)

(72) Inventor: Alexander GOETZ, Muenchen (DE)

(21) Appl. No.: 18/998,105

(22) PCT Filed: Jul. 19, 2023
(86) PCT No.: PCT/EP2023/070044

§ 371 Date: Jan. 23, 2025

(30) Foreign Application Priority Data
Jul. 25, 2022 (DE) 10 2022 118 490.0

(51) Int. Cl. B62D 15/02; B60W 30/12; B60W 50/08; B62D 6/08

(52) U.S. Cl. CPC B62D 15/025; B60W 30/12; B60W 50/082; B62D 6/08; B60W 2520/10; B60W 2540/12; B60W 2540/18; B60W 2540/20; B60W 2710/202

(57) ABSTRACT

A method for operating a lane guidance assistant of a vehicle includes activating an automated lateral guidance of the vehicle. In accordance with the activation a steering torque is applied by means of a steering system. The method also includes deactivating the automated lateral guidance in response to detecting at least one deactivation event. In accordance with the deactivation the applied steering torque is reduced within a deactivation duration. If it is determined that the at least one deactivation event is a driver-intervention event initiated by a driver of the vehicle, the deactivation duration is reduced to a reduced deactivation duration. In accordance with the deactivation, the steering torque is reduced within the reduced deactivation duration.

### BACKGROUND AND SUMMARY

The present invention relates to a method for operating a lane guidance assistant of a vehicle. In addition, the present invention relates to a lane guidance assistant for a vehicle. Finally, the present invention relates to a vehicle with such a lane guidance assistant.

Lane guidance assistants for vehicles are sufficiently well known from the prior art. Such lane guidance assistants, which are also referred to as steering and lane guidance assistants or active lane keeping assistants, are used in particular to keep the vehicle within a lane or a traffic lane. Such a lane guidance assistant uses the data of one or more of the environment sensors of the vehicle to detect the boundaries of a lane or the lane markings. If these lane markings are detected with sufficient certainty, the lane guidance assistant can be activated and it can perform steering interventions to keep the vehicle within the lane or traffic lane. For example, the steering interventions can be carried out in such a way that the vehicle is kept in the middle of the lane.

In the known prior art, there are essentially two different characteristics for the transition of an active lane guidance assistant from an active steering state to a passive non-steering state. The first possible transition is an abrupt removal of the steering assistance or the removal of the steering torque. This abrupt removal may be noticeable in the form of a detectable jerk in the steering wheel, which results from the discrete removal of the automatically set steering torque. The second known characteristic is a ramp-shaped removal of the automatically set steering torque for assistance. Here, a fixed deactivation duration or one dependent on the current speed is defined, during which the currently set steering torque, which can be 2 Nm, for example, is reduced to a steering assistance of 0 Nm.

It is the object of the present invention to reveal a solution as to how a lane guidance assistant of the type mentioned at the beginning can be improved in a situation-specific manner.

According to the invention, this object is achieved by a method, by a lane guidance assistant and by a vehicle with features according to one or more embodiments described herein.

A method according to at least one embodiment is used to operate a lane guidance assistant of a vehicle. The method involves activating an automated lateral guidance of the vehicle, wherein a steering torque is applied by means of a steering system when the lateral guidance is activated. In addition, the method includes deactivating the automated lateral guidance if at least one predetermined deactivation criterion is detected. When deactivation occurs, the applied steering element is reduced within a predetermined deactivation duration. Furthermore, the method includes the overall check of whether the at least one deactivation criterion that led to the deactivation of the automated lateral guidance is a driver intervention initiated by a driver of the vehicle. In addition, the methos includes the reduction of the deactivation duration to a reduced deactivation duration if the deactivation event is a or the driver intervention.

The lane guidance assistant may be used to assist a driver of the vehicle during steering tasks. In particular, the lane guidance assistant may be used to keep the vehicle within the traffic lane or the current lane. The lane guidance assistant can also be referred to as a steering and lane guidance assistant, an active lane keeping assistant or a steering assistant.

The lane guidance assistant can have at least one environment sensor by means of which environment data can be provided. These environment data describe an environment or surroundings of the vehicle. For example, the environment sensor can be a camera that can be used to provide image data as the environment data. By means of the lane guidance assistant or a computing device of the lane guidance assistant, lane boundaries can be detected in the environment data. In particular, the lane boundaries can be detected that bound the lane on which the vehicle is currently located. It may also be envisaged that lane boundaries of other lanes or adjacent lanes will be detected. The lane boundaries can be road markings, such as solid or dashed or broken lines. However, the lane boundaries can also be structural boundaries or the like. It may also be provided that the lane guidance assistant will be activated if the lane markings are not currently recognized, but a vehicle ahead is detected that is then followed in so-called following driving.

If these lane boundaries are reliably detected with a predetermined probability or reliability for a predetermined period of time, the lane guidance assistant can be activated. This means that a steering torque is provided by the lane guidance assistant or a steering system of the lane guidance assistant or steering interventions are carried out to keep the vehicle within the lane or the traffic lane. However, the steering torque or the steering intervention provided by the lane guidance assistant can be overridden by the driver at any time by operating the steering wheel.

As explained herein, predefined deactivation events can occur, which lead to the deactivation of the automated lateral guidance. Such a deactivation event can occur, for example, if the lane markings are not detected for a predetermined period of time or are not detected with sufficient certainty. In this case, the automated lateral guidance of the vehicle may be deactivated or the control of the vehicle may be handed over to the driver.

The deactivation does not occur abruptly, but within the predetermined deactivation duration. In particular, a notice or warning may first be issued to the driver that the automated lateral guidance is being switched off or that the driver should take the wheel again. During this deactivation duration, the steering torque provided by the steering system can be reduced. In particular, the steering torque can be completely reduced during the deactivation duration or reduced to a steering torque of 0 Nm. The steering torque can be reduced along a predetermined profile, such as a ramp.

According to the present invention, it is now envisaged that the deactivation event which led to the deactivation of the activated lane guidance assistant or the automated lateral guidance will be investigated in more detail. In particular, it will be checked whether the deactivation event is a driver intervention. In particular, a driver intervention can be the action carried out or initiated by the driver, which leads to the termination of the automated lateral guidance.

If it is now recognized that the deactivation event is a driver intervention or is caused by a driver intervention, the predetermined deactivation duration is reduced to the reduced deactivation duration. In other words, it is envisaged that in the event of a driver intervention, a reduced deactivation duration is used for shutting down or deactivation of the automated lateral guidance instead of the usually used deactivation duration. This reduced deactivation duration is shorter than the predetermined or usually used deactivation duration that is used for a different deactivation event prior to a driver intervention. In the case of a driver intervention, a reduced or shorter deactivation duration is used than in the case of deactivation events that are not caused by a driver intervention.

The present invention is based on the finding that when the steering assistance is withdrawn or the automated lateral guidance is deactivated, the driver or driver inputs are not taken into account. So it often happens that the active lane guidance assistant is deactivated by a steering intervention by the driver. Since according to the prior art no account is taken of the driver's inputs, the provided supporting steering torque is maintained for the predetermined deactivation duration in the event of a switch-off. This leads, for example, to the driver continuing to feel a force applied by the system to the steering wheel, which in most cases is directed against the steering direction desired by the driver or at least does not correspond exactly to the steering direction desired by the driver.

A driver who wants to cancel or deactivate the lane keeping assistant by entering their driver's input feels insecure about prior art systems if they only reduce the steering torque after or during the usually used deactivation duration, which can be a few seconds, for example. This reduces the comfort and safety felt by the driver while the lane guidance assistant is activated. In particular, this can lead to the driver “fighting” the system for a short period of time, although they actually wanted to switch it off by their steering intervention.

With the method according to the invention, it can now be achieved that the deactivation duration is reduced in the event of deactivation of the automated lateral guidance as a result of a driver intervention. This thus leads to faster deactivation of the automated lateral guidance in the event of a driver intervention. By reducing the deactivation duration in the event of the driver intervention, the driver can quickly regain control of the vehicle. This can also reduce conflicts that arise, for example, when a driver acts against a steering torque that is still applied. Overall, it can thus be achieved that comfort and safety in the operation of the lane keeping assistant are increased.

Preferably, the steering torque provided can be reduced in a ramp-like manner or along a ramp during the deactivation duration or the reduced deactivation duration. When determining the ramp-down time, the driver's condition and the driver's inputs can therefore be taken into account. During the deactivation duration or the reduced deactivation duration, a ramp-like reduction of the assisting steering torque is provided for the deactivation of the steering assistance. For example, in order to determine the reduced deactivation duration, i.e. the increase in the steering torque to be ramped down, it can be evaluated whether or not a driver intervention is the cause of the deactivation of the active lane guidance assistant.

In at least one embodiment, a steering wheel torque applied by the driver to a steering wheel of the vehicle and/or a change in a steering wheel angle caused by the driver on the steering wheel is detected as a driver intervention. The steering wheel torque can describe the torque applied by the driver to the steering wheel. For example, the automated lateral guidance can be deactivated if the steering wheel torque exceeds a predetermined limit. The automated lateral guidance can also be deactivated if the rate of change in steering wheel torque against time exceeds a predetermined limit. Alternatively or additionally, the automated lateral guidance can be deactivated if a change in steering wheel angle and/or a rate of change in steering wheel angle against time exceeds a limit value. So, if predetermined operating actions or steering interventions on the steering wheel by the driver are detected, this can be considered a deactivation event and thus the automated lateral guidance can be deactivated. In these cases, it can be assumed with a high degree of probability that the driver wants to deactivate the automated lateral guidance as quickly as possible.

Activation of the direction indicators of the vehicle initiated by the driver of the vehicle is preferably detected as a driver intervention. In other words, operation of the turn signal lever or the activation of the indicator can be considered as a driver initiated deactivation event or as a driver intervention. This applies both to the event in which the driver moves the turn signal lever into a snap-in position or a tapping indicator position. In the snap-in position, the corresponding direction indicators are permanently activated without the driver having to hold the turn signal lever closed. In the case of the tapping indicator position, the corresponding direction indicators can be activated for a predetermined period of time or for predetermined flashing cycles, wherein the turn signal lever reverts to the resting position when released. It can also be assumed that the driver wants to deactivate the activated lane guidance assistant when operating the turn signal lever or activating the direction indicator.

In at least one embodiment, a driver operation of a brake pedal of the vehicle is detected as a driver intervention. For example, the lane guidance assistant or the automated lateral guidance can be coupled to an automated speed control, in particular an adaptive cruise control (ACC). Such a speed control can be deactivated by pressing the brake pedal. If the driver now presses the brake or brake pedal, it can be assumed with a high degree of probability that the driver wants to deactivate the combined assistance of longitudinal control and lateral guidance.

Furthermore, it is advantageous if a type and/or intensity of the driver intervention is determined and the reduced deactivation duration is determined depending on the type and/or intensity of the driver intervention. In particular, the type of the driver intervention can describe which driver intervention was detected. For example, it can be checked whether the driver intervention was detected as a steering wheel torque applied by the driver to the steering wheel, an operation of the turn signal lever and/or operation of the brake pedal. For example, if the driver applies a steering torque to the steering wheel, a shorter deactivation duration can be selected compared to the case where the driver only operates the turn signal lever. If, for example, the driver applies a steering wheel torque to the steering wheel and thus wants to steer the vehicle manually, it can be assumed that he wishes to end the function of the lane keeping assistant as quickly as possible. It can also be checked whether the driver has performed multiple driver interventions. If multiple driver interventions are detected, the deactivation duration can be further reduced.

The intensity of the driver intervention can describe the magnitude of the steering wheel torque or the magnitude of the steering wheel angle, for example. In addition, to determine the intensity, the change in the steering wheel torque and/or the steering wheel angle as a function of time should be taken into account. This makes it possible to determine, for example, whether the driver only slightly overrides the steering torque provided by the steering system or whether a significant steering intervention is made by the driver. In the event of a significant steering intervention or a high steering wheel torque or a large change in the steering wheel angle, a shorter reduced deactivation duration can be selected. Overall, therefore, it can be derived how quickly or urgently the driver wants to end the automated lateral guidance. Based on this information, the reduced deactivation duration can then be determined.

In another embodiment, a current speed of the vehicle and the deactivation duration are each predetermined depending on the current speed. The usually used or the standard deactivation duration can be predetermined as a function of the current speed of the vehicle. For example, the deactivation duration can be reduced as the speed increases. The reduced deactivation duration, which is determined as a result of the driver's intervention, can then be determined on the basis of the speed-dependent deactivation duration. In other words, a cascade may be envisaged, in which the deactivation duration is first determined depending on the speed of the vehicle and then, if appropriate, a reduction in the deactivation duration can be provided in the event of a driver intervention.

A lane guidance assistant according to the invention for a vehicle is set up to activate automated lateral guidance of the vehicle, wherein a steering system applies a steering torque when lateral guidance is activated. Furthermore, the lane guidance assistant is set up to deactivate the automated lateral guidance if at least one predetermined deactivation criterion is detected, wherein when the deactivation occurs the steering system reduces the applied steering torque within a predetermined deactivation duration. In addition, the lane guidance assistant is set up to check whether the at least one deactivation event that has led to the deactivation of the automatic lateral guidance is a driver intervention initiated by a driver of the vehicle. In addition, the lane guidance assistant is also set up to reduce the deactivation duration to a reduced deactivation duration if the deactivation event is a driver intervention.

The lane guidance assistant may be set up to control the vehicle within the lane or the traffic lane. The lane guidance assistant may have an environment sensor, in particular a camera, which can be used to record lane markings. In addition, the lane guidance assistant may have a corresponding steering system, by means of which the automated lateral guidance can be carried out. Furthermore, the lane guidance assistant can be set up to detect a driver intervention. For example, the operation of the steering wheel, the operation of the turn signal lever and/or the application of the brake can be detected as a driver intervention.

A vehicle according to the invention contains a lane guidance assistant according to the invention. The vehicle is in particular in the form of a passenger car.

The preferred embodiments and the advantages thereof presented in relation to the method according to the invention apply correspondingly to the lane guidance assistant according to the invention as well as to the vehicle according to the invention.

Further features of the invention result from the claims, the figures and the description of the figures. The features and combinations of features mentioned above in the description as well as the features and combinations of features mentioned below in the description of figures and/or in the figures alone can be used not only in the respective specified combination, but also in other combinations or on their own, without departing from the scope of the invention.

One or more aspects of the invention will now be described with reference to the accompanying drawings.

### BRIEF DESCRIPTION OF THE DRAWINGS

FIG. 1 shows a schematic representation of a vehicle having a lane guidance assistant;

FIG. 2 shows a vehicle according to FIG. 1 in an exemplary traffic situation in the vicinity of an exit;

FIG. 3 shows a time profile of a steering torque during the automated lateral guidance and during the deactivation of the automated lateral guidance, wherein the deactivation does not take place as a result of a driver intervention;

FIG. 4 shows a time profile of a steering torque during the automated lateral guidance and during the deactivation of the automated lateral guidance, wherein the deactivation does take place as a result of a driver intervention

FIG. 5 shows a schematic flow diagram of a method for operating a lane guidance assistant.

### DETAILED DESCRIPTION OF THE DRAWINGS

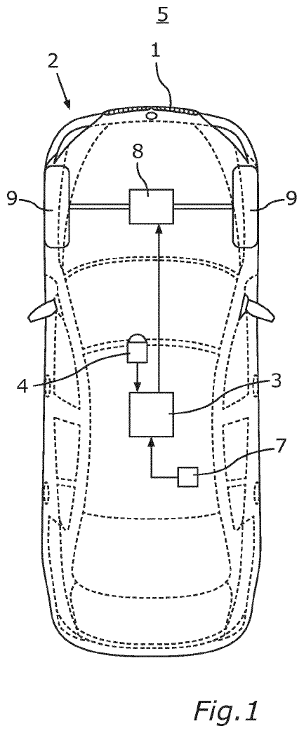

FIG. 1 shows a vehicle 1, which in the present case is in the form of a passenger car, in a plan view. The vehicle 1 contains a lane guidance assistant 2, by means of which the vehicle 1 can be kept within a lane 6 or a traffic lane. The lane guidance assistant 2 contains a computing device 3, which can be formed, for example, by at least one electronic control unit of the vehicle 1.

In addition, the lane guidance assistant 2 contains at least one environment sensor 4. In the example shown, the lane guidance assistant 2 contains an environment sensor 4, which in the present case is in the form of a camera. The environment sensor 4 can be used to provide environment data or image data that describe an environment 5 of the vehicle 1.

The computing device 3 is also set up to control a steering system 8 of the vehicle 1, which is only schematically shown in the present case. By controlling the steering system 8 a steering torque or steering intervention can be generated to keep the vehicle 1 within the lane 6 or traffic lane. By controlling the steering system 8, the steerable wheels 9 of the vehicle 1 can be steered and thus the lateral guidance of the vehicle 1 can be influenced.

In addition, the lane guidance assistant 2 contains a detection device 7, which can be used to detect a driver intervention. A driver intervention can be a steering wheel torque that is applied to a steering wheel by the driver of the vehicle 1. In addition, the driver intervention can be a change in a steering wheel angle, which is carried out by the driver on the steering wheel. In addition, the driver intervention may involve the operation of a turn signal lever of the vehicle. Finally, the driver intervention can be an operation of a brake pedal by the driver.

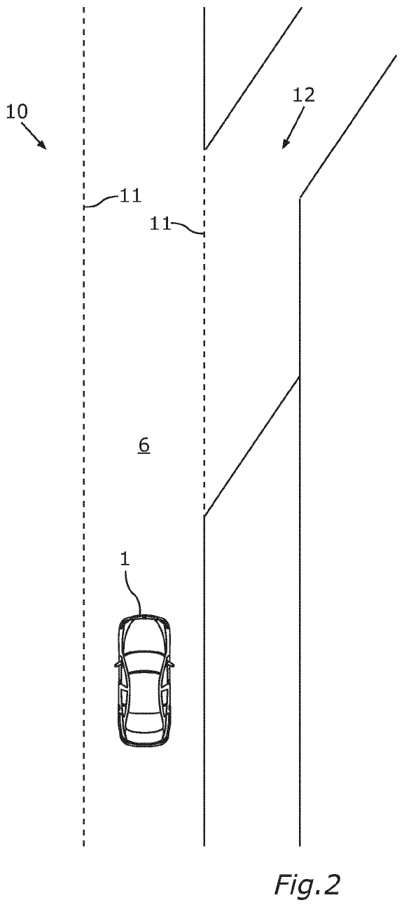

FIG. 2 shows vehicle 1 according to FIG. 1 in a schematic traffic situation. Here the vehicle 1 is in a lane 6. This lane 6 is associated with a street 10. The lane 6 is bounded by lane boundaries 11. Lane boundaries 11 are corresponding road markings that are applied to the surface of the road. By means of the computing device 3, these lane boundaries 11 or the lane markings can be detected on the basis of the environment data provided by the environment sensor 4. If these lane boundaries 11 can be reliably detected, the functionality of the lane guidance assistant 2 can be activated. For this purpose, the lane guidance assistant makes appropriate steering interventions in the steering system 8, so that the vehicle 1 is guided within the lane 6, for example.

In the present case, it is assumed that in the traffic situation shown in FIG. 2, the driver only notices late that he wants to leave the road 10 or the lane 6 via an exit 12. The driver activates the turn signal indicator and tries to steer the vehicle 1 quickly onto the exit 12. These driver interventions lead to a deactivation of the automated lateral guidance.

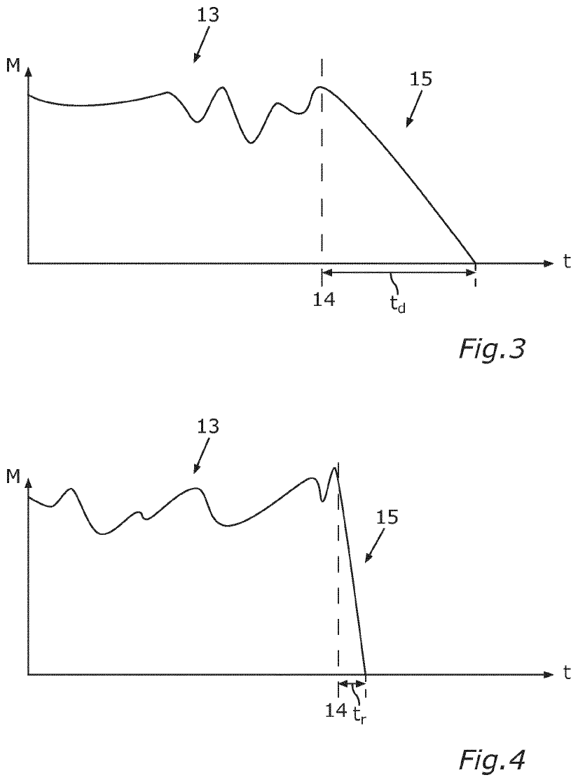

FIG. 3 shows the steering torque M applied by the steering system 8 as a function of the time t. In a first region 13, the time profile of the steering torque M during the automated lateral guidance of the vehicle 1 is shown. At a deactivation time 14, a deactivation event is detected, which leads to the deactivation of the active lateral guidance. In a region 15, the time profile of the steering torque M during the deactivation of the automated lateral guidance is shown. It can be seen that the steering torque M is reduced to a value of 0 Nm in the form of a ramp during a deactivation duration td. The deactivation duration td, during which the deactivation of the automated lateral guidance is carried out, can be a few seconds, for example.

In the example of FIG. 2, deactivating the automated lateral guidance within the deactivation duration td usually used, as shown by way of example in FIG. 3, would possibly lead to the driver becoming uncertain. In the case shown, the driver wants to deactivate the automated lateral guidance or the lane guidance assistant 2 as quickly as possible through his driver intervention in order to take the exit 12. The relatively long deactivation duration td can lead to the driver applying a steering wheel torque that is directed against the steering torque M of the steering system 8 or at least partially deviates from the steering torque M.

It is envisaged that a driver intervention will be detected as a deactivation event, and that if a driver intervention is detected, the deactivation duration td will be reduced to a reduced deactivation duration tr. This is exemplified in FIG. 4, which shows the steering torque M provided by the steering system 8 as a function of the time t. Here, too, the time profile of the steering torque M is shown during the activated lateral guidance. If a driver intervention is detected in the form of steering wheel operation, turn signal lever operation and/or brake application, the deactivation duration td is reduced to a reduced deactivation duration tr. For example, the reduced deactivation duration tr can be a few milliseconds. This is shown schematically in the present case in region 15 in FIG. 4.

By adjusting or reducing the deactivation duration td to the reduced deactivation duration tr, the following situation results in the traffic situation according to FIG. 2: By means of the lane guidance assistant 2, the operation of the steering wheel and/or of the turn signal by the driver is detected. Thus, a very short deactivation duration tr is determined as the optimum, so that after only a few milliseconds no steering torque M is applied by the steering system to the steering wheel or the steering of the vehicle 1. The driver can thus change lanes from the lane 6 to the exit 12 quickly without hindrance.

Based on the situation in FIG. 2, it is assumed that the lane boundaries 11 or the lane markings can no longer be reliably detected in the further journey. This also represents a deactivation event that leads to the shutdown of the lane guidance assistant 2. Since this shutdown is not a driver input initiated by the driver, the usually used deactivation duration td of more than one second is determined as the optimum.

At the switch-off time 14, the driver is preferably informed by a visual warning about the deactivation of the lane guidance assistant and he starts after a very short reaction time to regain full control of the vehicle automatically and steers the vehicle 1 himself. In this case, this relatively long deactivation duration td ensures that the vehicle 1 will continue to be kept on the current course by an automated steering torque M and the driver can take control without any fuss. Since no steering movement by the driver is to be expected immediately that points in a different direction than the system initially steered, the longer deactivation duration td is unproblematic in the sense of comfort and conflict with the driver.

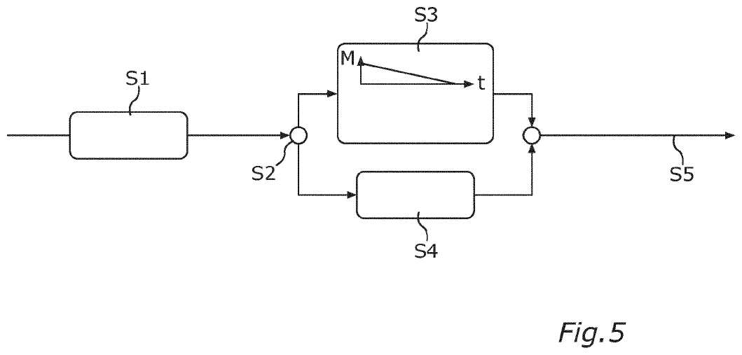

FIG. 5 shows a schematic flow diagram of a method for operating a lane guidance assistant 2 of a vehicle 1. In a step S1, the current speed of the vehicle 1 is determined. Depending on the current speed of the vehicle 1, the deactivation duration td can be determined. For example, at higher speeds, a shorter deactivation duration td can be selected. In a step S2, when a deactivation event is detected, a determination is made as to whether the deactivation event is a driver input or not. If the deactivation event is a driver input, the method is continued in a step S3. Depending on the type and/or intensity of the driver intervention, the reduced deactivation duration tr is determined. In particular, the ramp-shaped reduction of the steering torque M can be determined depending on the time t.

If the query in step S2 detects that it is a deactivation event that is different from a driver input, the method is continued in a step S4. Here the speed-dependent deactivation duration td is not reduced. In a step S5, the optimized deactivation duration td or the reduced deactivation duration tr can be output for the current driving situation.

1-8. (canceled)

9. A method for operating a lane guidance assistant of a vehicle, comprising:
activating an automated lateral guidance of the vehicle, wherein in accordance with the activation a steering torque is applied by means of a steering system;
deactivating the automated lateral guidance in response to detecting at least one deactivation event, wherein in accordance with the deactivation the applied steering torque is reduced within a deactivation duration;
determining that the at least one deactivation event is a driver-intervention event initiated by a driver of the vehicle;
reducing the deactivation duration to a reduced deactivation duration in response to determining that the deactivation event is the driver-intervention event; and
in accordance with the deactivation, reducing the steering torque within the reduced deactivation duration.

10. The method of claim 9, wherein the driver-intervention event comprises: driver-applied steering wheel torque and/or steering wheel angle change.

11. The method of claim 9, wherein the driver-intervention event comprises: driver-initiated turn-signal activation.

12. The method of claim 9, wherein the driver-intervention event comprises: driver-initiated braking.

14. The method of claim 9, further comprising:
determining a type and/or an intensity of the driver intervention event, wherein the reduced deactivation duration is determined based on the determined type and/or intensity of the driver intervention event.

15. The method of claim 9, wherein the deactivation duration is predetermined as a function of a current speed of the vehicle.

16. A lane guidance assistant for a vehicle, comprising:
at least one sensor configured to detect at least one driver-intervention event;
an electronic control unit, configured to:
activate an automated lateral guidance of the vehicle, wherein in accordance with the activation a steering torque is applied by means of a steering system;
deactivate the automated lateral guidance in response to detecting the at least one deactivation event, wherein in accordance with the deactivation the applied steering torque is reduced within a deactivation duration;
determine that the at least one deactivation event is a driver-intervention event initiated by a driver of the vehicle;
reduce the deactivation duration to a reduced deactivation duration in response to determining that the deactivation event is the driver-intervention event; and
in accordance with the deactivation, reduce the steering torque within the reduced deactivation duration.

17. A vehicle with a lane guidance assistant of claim 16.
